(19) United States
(12) Patent Application Publication
(10) Pub. No.: US 2002/0096168 A1
(43) Pub. Date: Jul. 25, 2002

(54) BBQ easy cleaning basket

(76) Inventors: Richard Weinmann SR., Parlin, NJ (US); Milan Korman, Perth Amboy, NJ (US)

Correspondence Address: Richard Weinmann & Milan Korman, 50 Albert Drive, Parlin, NJ, 08859, US

(21) Appl. No.: 09/692,383

(22) Filed: Jan. 19, 2001

(51) Int. Cl. F24C 1/16; A47J 37/00

(52) U.S. Cl. 126/9 R; 126/25 R; 126/41 R

(57) ABSTRACT

The BBQ Easy Cleaning Basket is made from expanded metal, metal mesh, etc. It has 2 parts; top and bottom held together by metal connecting screws, with a handle on each side. The basket is filled with various stones and/or briquettes and is to be placed in the BBQ body. The purpose is to keep all stones and/or briquettes together, therefore allowing even heat distribution while cooking. After cooking the stones and/or briquettes are covered by food residue and grease drippings. This is our main idea; that the stones and/or briquettes are rotated all at once and the residue is burned from the bottom, because the Easy Cleaning BBQ Basket is placed over the burner in the BBQ as shown.

### CLAIM

We claim that this is a specifically designed “BBQ Easy Cleaning Basket” for maintaining and easy rotation, of a variety of BBQ stones, used in any barbeque as shown and described.

### SUMMARY OF THE INVENTION

The purpose of this invention is to make barbeque cleaning easier and convenient for all.

The basket, made from metal mesh, is used to maintain a variety of barbeque stones and make it easy when cleaning those stones.

Our invention is easy to use, and has many incentives.

The advantages of our product are to save time, instead of rotating BBQ stones one at a time you rotate them all at once. The basket keeps stones all together in place of having them scattered in your barbeque. It also makes cleaning time shorter, and food tastes better because there is no residue from previous cooking.

### DESCRIPTION OF THE DRAWING

The invention together with its objects and the advantages thereof, may be understood by reference to following description taken in conjunction whit the accompanying drawings, In which like reference numerals identify like elements in the figure and which:

FIG. 1 is an exploded view of the invention;

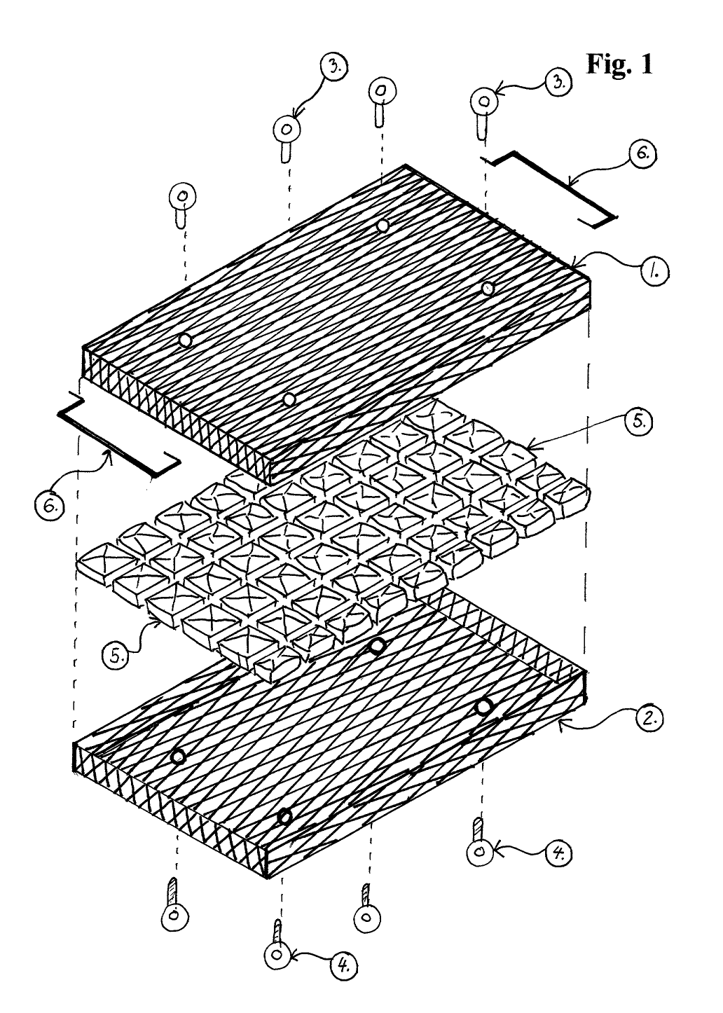

FIG. 2 is a section view of the invention;

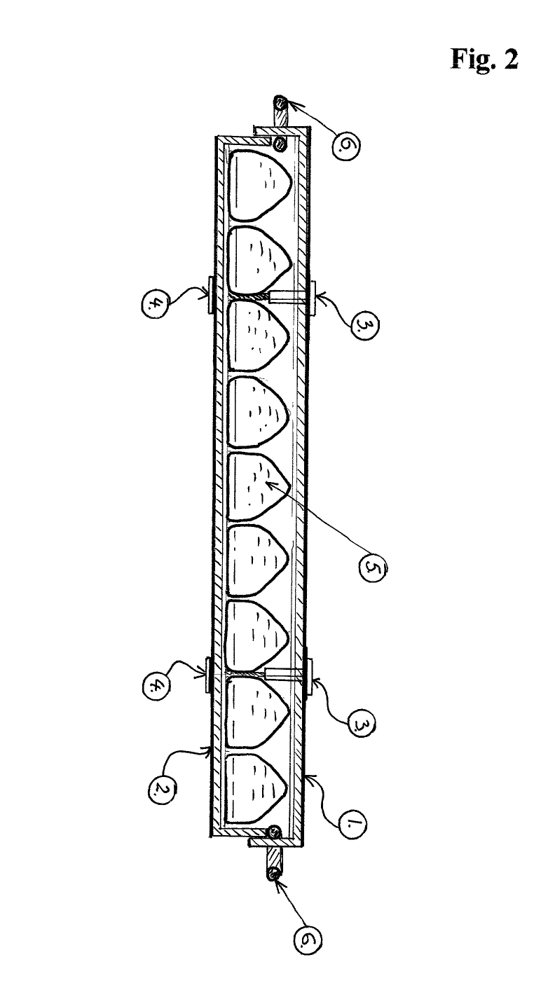

FIG. 3 is another section view of the invention;

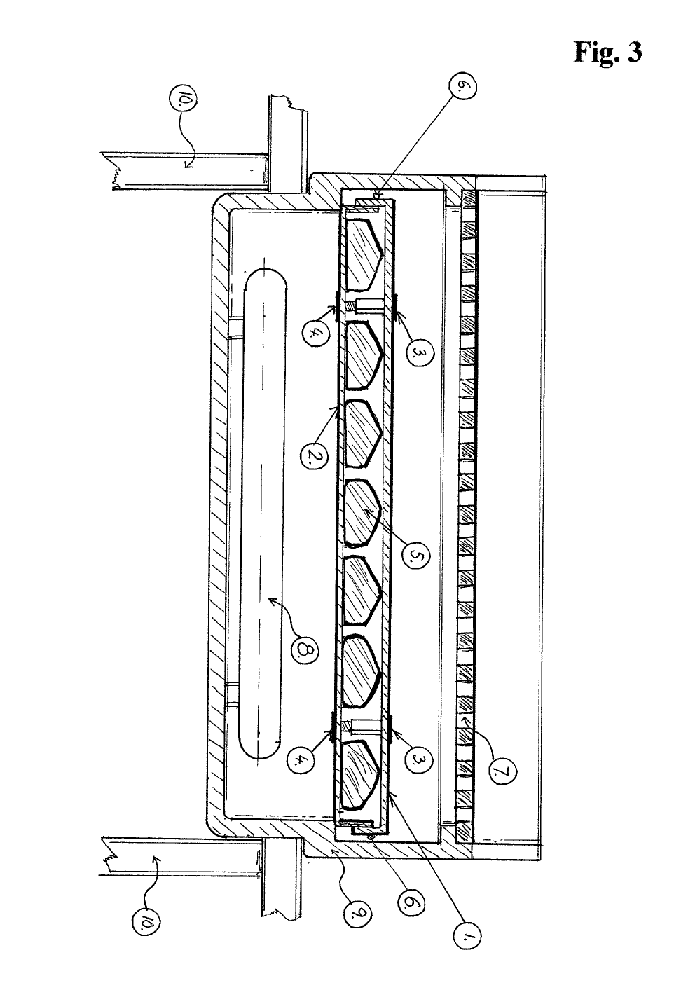

### DETAILED DISCRIPTION OF THE PREFERRED EMBODIMENT

1. Top section of the basket, made from metal mesh, which could also be made in different dimensions, shapes, and from various materials.

2. Bottom section of the basket, made from metal mesh, which could also be made in different dimensions, shapes, and from various materials.

3. Metal cap nut clasping the top and bottom sections of basket together. Adjustability of screws, gives you the opportunity to use different size and shape of barbeque stones, lava rocks, charcoals, etc.

4. Metal connect bolt, clasping the top and bottom sectors of basket together.

5. In this drawing, pyramid shaped BBQ rocks are illustrated, but any shape, or variety of BBQ rocks, stones, charcoal, etc. can be used.

6. Handles, used for placing and rotating of the basket.

7. Barbeque Metal Rack

8. Gas Burner

9. Body of Barbeque Grill

10. Barbeque Frame

1. A rectangular box, made of metal mesh, made of two parts, held together by adjustable metal screws, with inserted metal handles that give easy access for rotation, insertion, and removal, in and out of the barbeque body. It is filled with barbeque briquettes, stones, or charcoals, and gives access to rotation for all briquettes, stones, or charcoals, to be turned at once, with even heat distribution for barbequing. The box would be made in different sizes and shapes, depending one size of your barbeque.
